(19) United States
(12) Patent Application Publication
(10) Pub. No.: US 2011/0071941 A1
(43) Pub. Date: Mar. 24, 2011

(54) ELECTRONIC PLATFORM FOR FACILITATING INTERNATIONAL FINANCIAL TRANSACTIONS

(75) Inventor: Iker Marcaide, Valencia (ES)

(73) Assignee: peerTransfer Corporation, Cambridge, MA (US)

(21) Appl. No.: 12/888,507

(22) Filed: Sep. 23, 2010

Related U.S. Application Data
(60) Provisional application No. 61/245,638, filed on Sep. 24, 2009.

(51) Int. Cl. G06Q 40/00

(52) U.S. Cl. 705/39

(57) ABSTRACT

An electronic platform to facilitate international financial swaps between businesses and individuals in different countries, in different countries, comprises a data bank for receiving financial transfer requests; a market clearing system with the ability to match requests from a party to transfer funds from one country to another with one or more complementary requests from another party or parties; a market making system with the ability to add liquidity to facilitate swaps; and an executing system with the ability to transfer funds between matched parties and complete a swap.

### CROSS-REFERENCE TO RELATED APPLICATIONS

This application claims the benefit, under 35 USC 119(e) of prior provisional application No. 61/245,638, Filed Sep. 24, 2009 and titled “ELECTRONIC PLATFORM FOR FACILITATING INTERNATIONAL FINANCIAL TRANSACTIONS.”

### BRIEF DESCRIPTION OF THE DRAWINGS

FIG. 1 is a flow diagram of the electronic platform logic sequence according to an exemplary embodiment for practicing some aspects of the invention;

FIG. 2 is a flow diagram showing the series of events for an international financial exchange according to an exemplary embodiment for practicing some aspects of the invention.

### DETAILED DESCRIPTION

The following detailed description provides one or more example modes of carrying out exemplary embodiments of some aspects of the invention. The description is not to be taken in a limiting sense, but is made merely for the purpose of illustrating the general principles of the invention, since the scope of the invention is defined by the appended claims.

Broadly, in some embodiments, an electronic platform is shown to facilitate financial swaps between individuals and ‘businesses in different countries and using different currencies.

Embodiments of the electronic platform according may comprise a data bank for financial transfer requests; a market clearing system with the ability to match requests from at least one party to transfer funds from one country to another with one or more complementary requests from at least one other party; and an executing system with the ability to transfer funds and complete the swap. A market making system with the ability to add liquidity to facilitate a swap may be included. Alternatively, a party could request a conversion of the currency of one country to that of another. The electronic platform logic may implement the following steps:

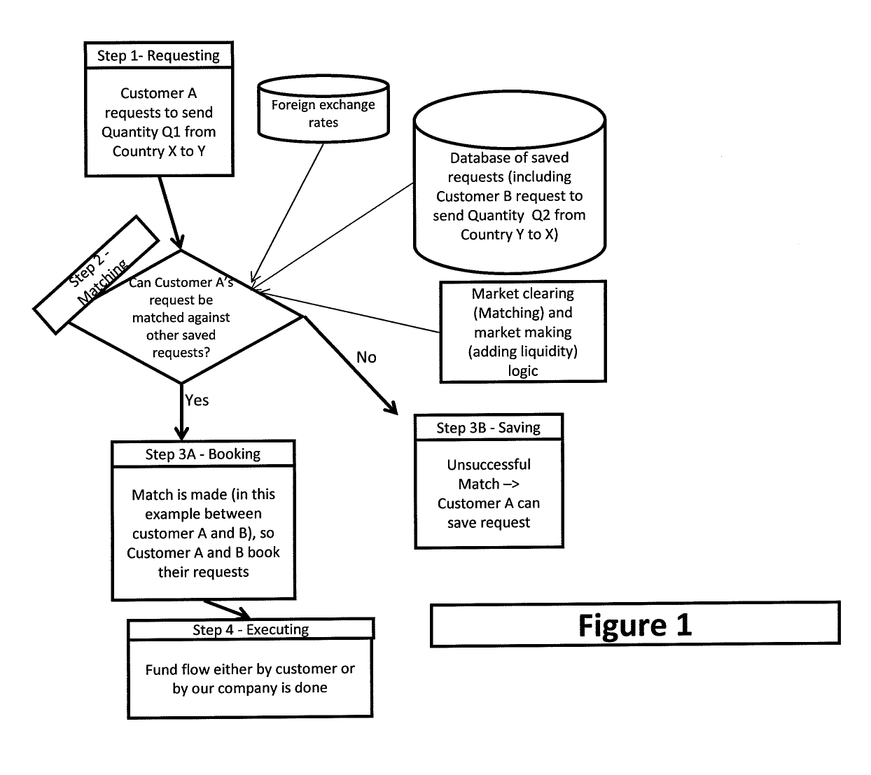

Step 1: Requesting: Customer A provides a request for a financial transfer of a sum Q1, specifying the country of origin and country of destination. Using the scheme of FIG. 1, Customer B has requested the financial transfer of a sum Q2 from country Y to country X, receiving Q1 in country X. This request is stored in the saved requests database when the request arrives from Customer A that Q1 is to be sent from country X to country Y, receiving Q2 in country Y (Q1 and Q2 are related by the exchange rate between the corresponding currencies). The customer preferably has bank accounts in the countries of origin and/or destination.

Step 2: Matching: The technology of the electronic platform follows logic for market clearing and market making, and also takes into account foreign exchange rates. The market clearing technology examines all saved requests from other users and determines whether the request of Customer A can be matched against one or more of the saved requests. In the case of FIG. 1, if the amount delivered by Customer A in country X is similar to the amount desired by Customer B in country X, and thus, after the exchange rate conversion the amount delivered by Customer B in country Y is similar to the amount desired by Customer A in country Y, then these two customers will be matched. The matching can be one-to-one, one-to-many, or many-to-many. For matching, cycles can be performed. For example, Customer A sending $1000 from US to UK, Customer B sending the equivalent of $1000 from UK to Spain, and a third Customer sending the equivalent of $1000 from Spain to US can be matched as a “cycle.”

The system also involves market making to give liquidity to the matching. For example, if one flow is $1000 from US to UK and another is $900 from UK to US, the technology can accept that as a match and provide internal funds to facilitate the transaction.

Steps 3A and 3B: Booking and Saving The technology provides a response to the customer for example, indicating that there is a successful or unsuccessful match. The customer then decides to take action. If it has been successful, he could book the transaction; if unsuccessful, he has several options, such as, but not restricted to, saving the request or sending the money at that time with a higher pricing, reflected in the exchange rates and fees offered. Following FIG. 1, Step 3A would be the action from the customer after a successful match (booking) and Step B would be the action after an unsuccessful match (saving the request). Booking will provide enough information as to meet regulatory requirements and payment execution needs. When saving the request, an expire date of such pending request is preferable but not necessary. Step 4: Executing.

In view of the customer action and with the provided information the payment is executed. In the case of FIG. 1, Customer A will have to deliver Q1 funds in country X and will receive Q2 funds in country Y. Throughout the process compliance procedures assure regulatory requirements are met. The system provider may, but is not required to execute all funds flows through debits and credits.

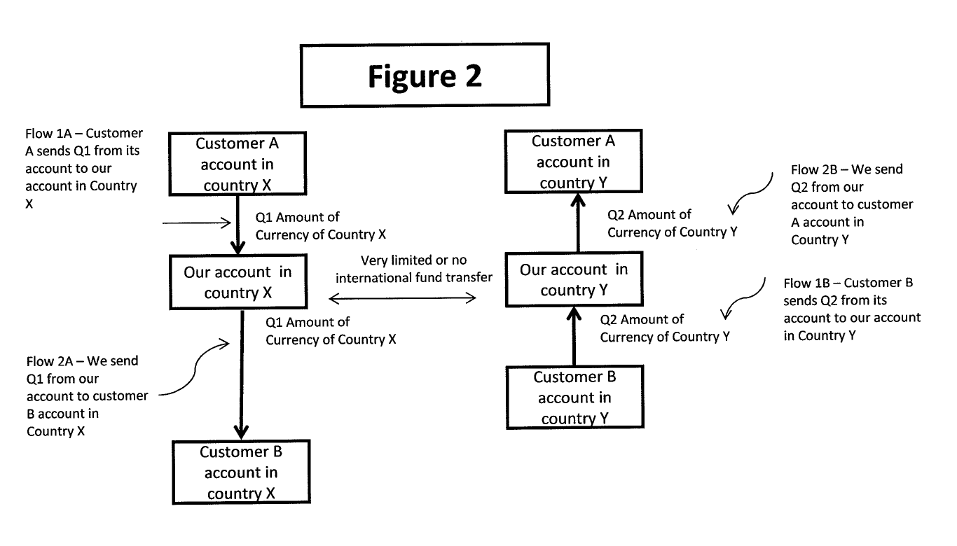

The fund flow is represented in FIG. 2. Customer A will fund the company account in country X for example, but not restricted to, through a credit or an authorized debit; this money will be used to fund Customer B's account in country X. Similarly, Customer B will fund the company account in country Y and that money will be used to fund Customer A's account in country Y. This produces a domestic compensation of funds, which avoids or limits greatly international fund flow with the associated costs of transmission and currency purchase.

Exemplary implementations may include (1) a front end and customer interface, to provide a way for customers to interact with the company to enable Steps 1, 3A and 3B of FIG. 1; (2) a market clearing technology to match requests and, if necessary, a market making technology to take positions to facilitate liquidity and enable Step 2 of FIG. 1; and (3) a back end system to process transactions enabling Step 4 of FIG. 1.

Variations of the described procedure can comprise a policy of providing the customer with a timeline of the time and amount available to swap instead of returning a successful or unsuccessful match. Also, the delivery of funds can be done in a sequential manner, with immediate partial delivery and the remainder in the future.

The concept of providing user-to-user matching can be useful in other applications where bypassing established systems can result in substantial cost savings and quality improvements. The matching can originate with the users themselves (user agreements), by a platform that serves as clearing house (matching) or by a platform that serves as clearing house and market maker (providing liquidity). Clearing house is the direct matching and market making is taking a position in non-perfectly matched transactions to give liquidity to the system and increase likelihood of transactions being feasible.

Other uses could include using the matching technology when domestic transactions are lower in cost and more reliable than international ones. By enhancing local compensation, international transactions are simplified into domestic ones. Extended uses of the platform include peer-to-peer, peer-to-business and business-to-business platforms where direct swap agreements or facilitated swaps (with market making) take place through a matching process. These uses can lie either within the financial services space or outside it. They could serve international or national customer needs. The platform is preferably but not necessarily electronic. In addition, prices might be fixed as determined using references of the rates at foreign exchange markets or determined by users in the their agreements, creating a marketplace where users offer and demand money in different currencies to be delivered across the globe or just within a country. Other uses within the money transfer and payment space include swapping electronically or physically foreign currency, swapping debt or funds or other financial products. Uses outside the financial services space can include swapping/exchanging any other services or physical goods based on a matching process. The platform can provide tracking information to increase reliability and visibility on the state of the fund transfer. It also produces a matching technology product that can be licensed for other purposes and performs the clearing house and market making function. The platform may also provide fund guarantees as well as matching technology. It increases liquidity in the market by assuming risks as market maker.

The described platform provides advantages in cost and reliability in international financial transactions. Currently, money transmitters or payment providers send money independently of local netting or transactions, thus not linking the company's cost structure with the customer pricing. There is no formal platform that facilitates swaps. The described processes maximize domestic compensation/netting and thus minimize international funds flow, reducing the currency purchase and international delivery costs for individuals and businesses while increasing reliability. Currently, these transactions are expensive. Taking a US to Europe transfer as an example, banking costs range between 2 to 6% of the value as a worst exchange rate, in addition to a fixed fee of $10 to $30. They are also unreliable since it is unusual that a provider has visibility from beginning to end of the transfer process. The electronic platform of the platform makes it possible to send money in different directions offering prices between 5 to 10 times lower as well as high reliability in the transactions.

It should be understood, of course, that the foregoing relates to exemplary embodiments of the platform and related methodology and that modifications may be made without departing from the spirit and scope of the invention as set forth in the following claims.

I claim:

1. An electronic platform to facilitate international financial swaps, comprising:
a data bank for receiving financial transfer requests;
a computer-operated market clearing system with the ability to match requests from a party to transfer funds from one country to another with one or more complementary requests in the data bank from one or more other parties; and
an executing system with the ability to electronically transfer funds to and from accounts of the parties and complete a swap.

2. The platform of claim 1, further including a market making system with the ability to add liquidity to facilitate swaps.
